(19) United States
(12) Patent Application Publication
(10) Pub. No.: US 2008/0107448 A1
(43) Pub. Date: May 8, 2008

(54) IMAGE FORMING APPARATUS AND IMAGE FORMING METHOD

(75) Inventors: Masashi Takahashi, Kanagawa-ken (JP); Takeshi Watanabe, Kanagawa-ken (JP); Minoru Yoshida, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/556,324

(22) Filed: Nov. 3, 2006

(51) Int. Cl. G03G 15/30

(52) U.S. Cl. 399/149

(57) ABSTRACT

To provide an image forming apparatus that performs image formation in accordance with a cleanerless system but less easily causes filming.

An image forming apparatus of a cleanerless system having at least a charging unit, an exposing unit, a developing unit, and a transferring unit around a photoconductive drum includes brush assemblies 62 and 63 arranged to extend along a rotation axis direction of a photoconductive drum 3 between the transferring unit and the charging unit in order to collect or perturb a residual toner after transfer, a brush assembly guide 61 that can bring a tip surface of brush fibers of the brush assembly retractably into contact with an outer peripheral surface of the photoconductive drum to be opposed to the outer peripheral surface of the photoconductive drum and guide the brush assembly movably along the rotation axis direction of the photoconductive drum, and brush assembly driving units 204, 205, and 206 that drive the brush assembly guided by the brush assembly guide to move along the rotation axis direction of the photoconductive drum.

### BACKGROUND OF THE INVENTION

1. Field of the Related Art

The present invention relates to an image forming apparatus of an electrophotographic system, and, more particularly to an image forming apparatus that uses a cleanerless process for collecting a residual toner, which is not used for transfer in a transfer process, in a development process and an image forming method therefor.

2. Description of the Related Art

A transfer technique by a corona charger opposed to a photoconductive member is well known as a related art concerning a transferring unit of an image forming apparatus that adopts the electrophotographic system. However, harmful ozone is generated in this system. Thus, as an ozoneless transfer technique, a transfer technique of a contact system is known. A technology for performing transfer using a semi-conductive transfer belt and a transfer roller provided on the rear surface of the transfer belt is disclosed in JP-A-6-110343. In the technique, the transfer of an image is performed by applying a transfer bias to the transfer roller.

As a color image forming apparatus that forms an image using plural toners of Y (yellow), M (magenta), C (cyan), and Bk (black), systems described in (1) to (4) below are known.

### (1) A system for superimposing toners of four colors one on top of another to form images on one photoconductive member and collectively transferring the images

### (2) A transfer drum system for holding a transfer material on a transfer drum and forming images of four colors by rotating the transfer drum four times

### (3) An intermediate transfer system for forming images of four colors one on top of another on an intermediate transfer member and collectively transferring the images onto a transfer material

### (4) A quadruple drum system in which four photoconductive members are arranged in parallel and images of four colors are formed while a transfer material passes once

The color image forming apparatus of the quadruple drum system multiply transfers color images, which are formed on four image bearing members (hereinafter referred to as photoconductive members or photoconductive drums) arranged in parallel, onto a transfer material (a print sheet) in one pass of the transfer material to form a color image. According to this method, there is an advantage that, compared with time for image formation processes for four colors by the other systems, it is possible to form an image in a quarter of the time. Thus, this method is suitable for an increase in speed of image formation.

In these image forming apparatuses, cleaning devices are set in order to clean a toner remaining on the photoconductive members after toner images formed on the photoconductive members are transferred onto the transfer material in a series of processes of image formation. As an image forming apparatus that adopts a system different from this system in which the cleaning devices are set, there is an image forming apparatus that uses a so-called cleanerless process for, with the cleaning devices removed, collecting a toner remaining on photoconductive members after transfer with developing devices and reusing the toner to reduce a quantity of toner consumption.

However, in the image forming apparatus that uses the cleanerless process, since independent cleaning devices are not arranged, the toner remaining on the photoconductive members adheres onto the surfaces of the photoconductive members to cause filming. Thus, for example, in a cleanerless image forming method disclosed in JP-A-5-61383, a technique for giving vibration to brushes using solenoids to prevent occurrence of filming is proposed.

In this case, planes formed by tips of brush fibers planted in the brushes are pressed against the photoconductive drums and fixed. Thus, the tips of the brush fibers gradually bend and sides of a large number of brush fibers slide on outer surfaces of the photoconductive drums. As a result, the effect of prevention of filming is deteriorated. When there is eccentricity of the outer surfaces of the photoconductive drums with respect to rotation axes, it is not easy to freely cope with the eccentricity. It is likely that vibration and noise due to the solenoids are caused.

### BRIEF SUMMARY OF THE INVENTION

The invention has been devised to solve the problems described above and it is an object of the invention to provide an image forming apparatus of a cleanerless system that has a silent and simple structure with high performance, does not easily cause filming in image bearing members (photoconductive drums), and can perform satisfactory image formation and an image forming method for the image forming apparatus.

In order to solve the problems, according to an aspect of the invention, there is provided an image forming apparatus of a cleanerless process system including: an image bearing member on which a latent image is visualized by a toner and transferred; and a memory removing member that is set retractably in contact with a surface of the image bearing member and provided to be slidable in a direction along the surface of the image bearing member.

According to another aspect of the invention, there is provided an image forming apparatus of a cleanerless process system including: image bearing means on which a latent image is visualized by a toner and transferred; and memory removing means that is set retractably in contact with a surface of the image bearing means and provided to be slidable in a direction along the surface of the image bearing means.

According to still another aspect of the invention, there is provided an image forming method of a cleanerless process system including: setting a memory removing member retractably in contact with a surface of an image bearing member; and sliding the memory removing member in a direction along the surface of the image bearing member.

### DESCRIPTION OF THE DRAWINGS

FIG. 1 is a sectional view showing an image forming apparatus of a quadruple tandem direct transfer system according to an embodiment of an image forming apparatus of the invention;

FIG. 2 is a diagram showing an image forming apparatus in which a transfer belt is used as an intermediate transfer belt;

FIG. 3 is a diagram showing a brush unit according to a first embodiment of a memory removing device used in the image forming apparatus in FIG. 1 or 2;

FIG. 4 is a diagram showing a brush unit according to a second embodiment of the memory removing device used in the image forming apparatus in FIG. 1 or 2;

FIG. 5 is a diagram showing a brush unit according to a third embodiment of the memory removing device used in the image forming apparatus in FIG. 1 or 2;

FIG. 6 is a graph showing a result of performing a filming test concerning a nylon brush and an acrylic brush using a conventional fixed jig and a jig by a Free mechanism of the brush unit according to the embodiment;

FIG. 7 is a schematic diagram for explaining a driving unit that causes a brush assembly of the brush unit shown in FIGS. 3 to 5 to reciprocatingly move in a rotation axis direction of a photoconductive drum;

FIG. 8 is a schematic diagram of a driving unit for explaining a method of driving the brush unit according to a method different from that shown in FIG. 7;

FIG. 9 is a diagram showing a lateral sliding mechanism for testing an influence on occurrence of filming due to a difference in an urging force at the time when a brush comes into contact with an outer surface of a photoconductive drum; and

FIG. 10 is a diagram for proposing a method of removing a carrier in an image forming apparatus of a two component development system.

### DESCRIPTION OF THE EMBODIMENT

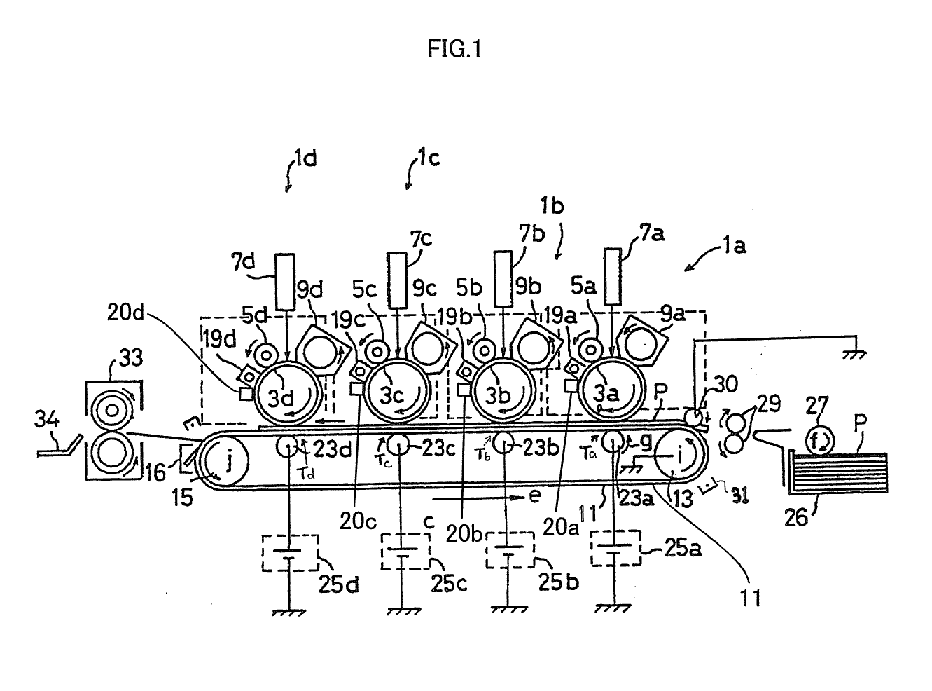

Embodiments of the invention will be hereinafter explained with reference to the accompanying drawings. FIG. 1 is a sectional view showing an example of an image forming apparatus of the invention, which is an image forming apparatus of a quadruple tandem direct transfer system. For convenience of explanations, first, sections other than a memory removing device according to this embodiment will be explained and, then, the memory removing device, which is a main section according to this embodiment, and the like will be explained.

In the image forming apparatus shown in FIG. 1, process units 1a, 1b, 1c, and 1d for forming images are provided. The respective process units have photoconductive drums 3a, 3b, 3c, and 3d serving as image bearing members (image bearing means) and form developer images (toner images) on these photoconductive drums. The process units 1a, 1b, 1c, and 1d serving as image forming devices corresponding to respective colors have substantially the same structure except colors of toners to be treated. Thus, first, the process unit 1a will be explained in detail.

The photoconductive drum 3a shown in FIG. 1 is formed in a cylindrical shape having a diameter of 30 mm and arranged to be rotatable in a direction of an arrow shown in the photoconductive drum. Units described below are arranged around the photoconductive drum 3a along the rotation direction. First, a charger (charging means) 5a is provided to be opposed to the surface of the photoconductive drum 1a. This charger 5a uniformly charges the photoconductive drum 3a in a negative polarity (−). It is possible to subject the photoconductive drum 3a to contact charging using a conductive roller, brush, blade, or the like instead of the charger.

An exposing device 7a is provided in an image forming apparatus body in a position downstream (in the rotation direction of the photoconductive drum) of the charger 5a. The exposing device 7a exposes the charged photoconductive drum 3a to light to form an electrostatic latent image. A developing device 9a having a developer of yellow stored therein is arranged downstream of the exposing device 7a. The developing device 9a subjects the electrostatic latent image formed by the exposing device 7a to reversal development using the developer stored therein. A conveyor belt 11 that conveys a print sheet P (a sheet P), which is a medium on which an image is formed (a transfer material), to the photoconductive drum 3a is set under the photoconductive drum 3a downstream of the developing device 9a. This conveyor belt 11 conveys the sheet P to the photoconductive drum 3a such that the developer image formed on the photoconductive drum 3a and the sheet P come into contact with each other and the developer image is transferred onto the sheet P.

A charge removing lamp 19a is provided further on a downstream side than a position where the photoconductive drum 3a and the sheet P are in contact with each other. After the transfer, the charge removing lamp 19a removes charges on the surface of the photoconductive drum 3a with uniform light irradiation. When one cycle of image formation is completed according to the charge removal by this charge removing lamp 19a, the charger 5a uniformly charges the un-charged photoconductive drum 3a again as a start of the next image formation process. However, in this example, a filming preventing device 20a is arranged upstream of the charge removing lamp 19a. In other words, the process unit 1a for yellow includes the photoconductive drum 3a, the charger 5a, the developing device 9a, the filming preventing device 20a, and the charge removing lamp 19a.

The image forming apparatus according to this embodiment is an image forming apparatus that adopts a cleanerless process not including a special-purpose cleaner. This embodiment of the invention intends to prevent occurrence of filming formed in a photoconductive drum of such an image forming apparatus in the past.

On the conveyor belt 11, other than the process unit 1a, the process units 1b, 1c, and 1d are arranged between a driving roller 15 and a driven roller 13 along a conveyance direction of the sheet P. All the process units 1b, 1c, and 1d have the same structure as the process unit 1a. In other words, the photoconductive drums 3b, 3c, and 3d are arranged substantially in the center of the respective process units. Chargers 5b, 5c, and 5d are arranged around the photoconductive drums 3b, 3c, and 3d, respectively. Exposing devices 7b, 7c, and 7d are arranged downstream of the chargers. Developing devices 9b, 9c, and 9d, filming preventing devices 20b, 20c, and 20d, and charge removing lamps 19b, 19c, and 19d are arranged downstream of the exposing devices in the same manner as the case of the process unit 1a. Developers stored in the developing devices are different. The developing device 9b stores a magenta developer, the developing device 9c stores a cyan developer, and the developing device 9d stores a black developer.

The sheet P conveyed by the conveyor belt 11 comes into contact with the respective photoconductive drums 3a, 3b, 3c, and 3d one after another. Transferring devices (transferring means) 23a, 23b, 23c, and 23d are provided in association with the respective photoconductive drums 3a, 3b, 3c, and 3d near positions where the sheet P and the respective photoconductive drums 3a, 3b, 3c, and 3d are in contact with each other. In other words, the transferring devices 23a, 23b, 23c, and 23d are arranged to be in contact with the rear surface of the conveyor belt 11 below the photoconductive drums 3a, 3b, 3c, and 3d corresponding thereto. Therefore, the transferring devices 23a, 23b, 23c, and 23d are arranged to be opposed to the process units via the conveyor belt 11. In this case, the transferring device 23a is connected to a plus (+) DC power supply 25a serving as voltage applying means. Similarly, the transferring devices 23b, 23c, and 23d are connected to DC power supplies 25b, 25c, and 25d, respectively.

In FIG. 1, a paper feeding cassette 26 that stores the sheets P is arranged on the right side of the conveyor belt 11 and the driven roller 13. In the image forming apparatus body, a pickup roller 27 that picks up the sheet P one by one from the paper feeding cassette 26 is provided to be rotatable in an arrow f direction in the figure. A registration roller pair 29 is rotatably provided between the pickup roller 27 and the conveyor belt 11. The registration roller pair 29 feeds the sheet P onto the conveyor belt 11 at predetermined timing. In FIG. 1, a fixing device 33 that fixes a developer on the sheet P and a paper discharge tray 34 to which the sheet P having the developer fixed thereon by the fixing device 33 is discharged are provided on the left side of the conveyor belt 11 and the driving roller 15.

A color image formation process of the image forming apparatus constituted as described above will be explained. When the start of image formation is instructed via a not shown operation panel (control panel) provided on the upper surface side of the image forming apparatus shown in FIG. 1, the photoconductive drum 3a receives a driving force from a not shown driving mechanism and starts rotation. The charger 5a uniformly charges this photoconductive drum 3a at about −600 V. The exposing device 7a irradiates light corresponding to an image that should be recorded and forms an electrostatic latent image on this photoconductive drum 3a uniformly charged by the charger 5a. The developing device 9a develops the electrostatic latent image with the developer to form a yellow developer image. According to the same procedure as the formation of the developer image on the photoconductive drum 3a, developer images of the respective colors are also formed on the photoconductive drum 3b, the photoconductive drum 3c, and the photoconductive drum 3d.

On the other hand, the pickup roller 27 takes out the sheet P from the paper feeding cassette 26. The registration roller pair 29 supplies this sheet P onto the conveyor belt 11. The conveyor belt 11 sequentially conveys the sheet P to the photoconductive drum 3a, the photoconductive drum 3b, the photoconductive drum 3c, and the photoconductive drum 3d.

When the sheet P reaches a transfer area Ta formed by the photoconductive drum 3a, the conveyor belt 11, and the transfer member 23a, a bias voltage of about +1000 V is applied to the transferring device 23a. A transfer electric field is formed between the transferring device 23a and the photoconductive drum 3a. The developer image on the photoconductive drum 3a is transferred onto the sheet P in accordance with this transfer electric field. The sheet P having the developer image transferred thereon in the transfer area Ta is conveyed to a transfer area Tb. In the transfer area Tb, a bias voltage of about +1200 V is applied to the transferring device 23b from the DC power supply, whereby a magenta developer image is transferred onto the sheet P to be superimposed on the yellow developer image.

After the magenta developer image is transferred, the sheet P is further conveyed to a transfer area Tc and a transfer area Td. A bias voltage of about +1400 V is applied to the transferring device 23c in the transfer area Tc, whereby a cyan developer image is transferred onto the sheet P to be superimposed on the developer images already transferred. Moreover, a voltage of about +1600 V is applied to the transferring device 23d in the transfer area Td, whereby a black developer image is transferred onto the sheet P. The developer images of the respective colors multiply transferred one after another in this way are fixed on the sheet P by the fixing device 33 and a color image is formed. The sheet P having the developer images fixed thereon is discharged to the paper discharge tray 34.

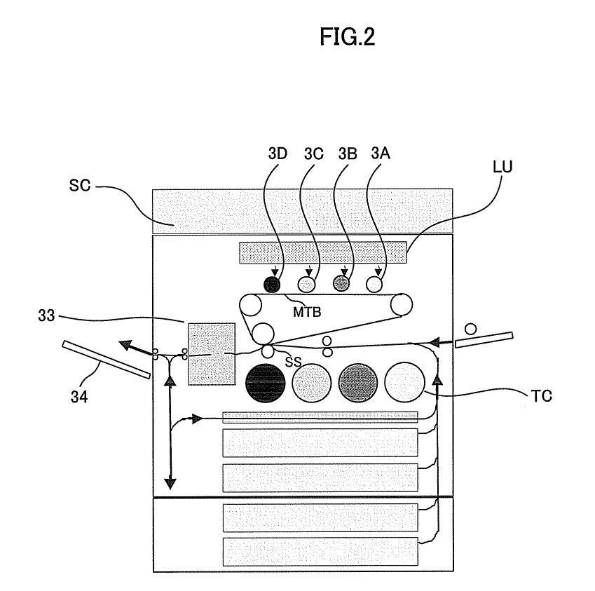

An example of the image forming apparatus in which the transfer belt is constituted as the intermediate transfer belt is shown in FIG. 2. In this case, toner images formed on the respective photoconductive members 3A to 3D (Y, M, C, and Bk) are primarily transferred onto an intermediate transfer belt MTB. The toner images are collectively transferred onto the sheet P conveyed in a secondary transfer section SS. Thereafter, the sheet P is conveyed to the fixing unit 33 to have the images fixed thereon and discharged to the paper discharge tray 34. In FIG. 2, reference sign SC denotes a scanner; LU, a laser unit; and TC, a toner cartridge.

### First Embodiment

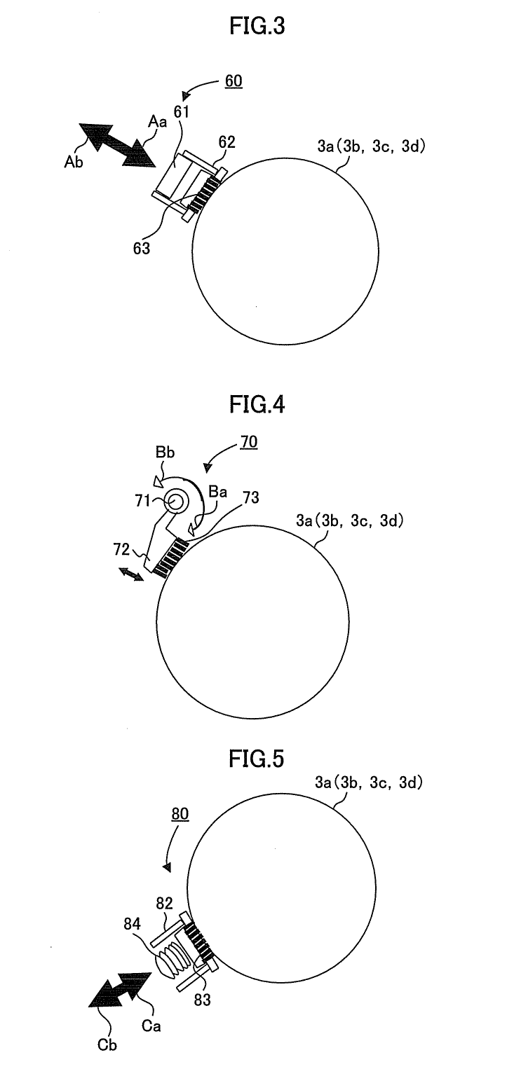

A first embodiment of the image forming apparatus of the invention will be explained. FIG. 3 is a diagram for explaining a brush unit of a memory removing device used in the first embodiment of the image forming apparatus of the invention. The memory removing device includes the brush unit and a driving unit (described later) that drives a brush assembly of the brush unit. A brush unit 60 in FIG. 3 includes a brush guide 61 attached to an image forming apparatus body, a brush frame 62 that can freely move in linear directions indicated by arrows Aa and Ab (directions perpendicular to the surface of a photoconductive drum (a normal direction)) while holding the brush guide 61, and a brush (a memory removing member, memory removing means) 63 attached to the brush frame 62.

The brush frame 62 and the brush 63 are referred to as a brush assembly. This brush assembly is made slidable in an axial direction of the photoconductive drum as well. The brush unit 60 extends in the axial direction of the photoconductive drum in the same degree as the rotor drum. The brush 63 also extends in the axial direction of the photoconductive drum as a substantially fixed width in the same degree as the rotor drum. The brush guide 61 guides the brush frame 62 from the inner side of the brush frame 62. However, the brush guide 61 may guide the brush frame 62 from the outer side of the brush frame 62.

Fibers used in the brush 63 are set to substantially the same length and the tips of the brush fibers are formed to be on the same plane. The brush unit 60 according to this embodiment is preferably assembled such that, when the brush 63 and the photoconductive drum come into contact with each other, concerning the tip plane formed by the tips of the brush fibers, a center line of the tip plane extending along the length direction of the photoconductive drum is parallel to a rotation axis of the photoconductive drum and the rotation axis of the photoconductive drum is placed on an imaginary plane that passes the center line of the tip plane and is perpendicular to the tip plane. In other words, it is preferable that, in the brush unit 60, when the tip plane formed by the tips of the brush fibers comes into contact with the surface of the photoconductive drum, the tip plane is opposed to the rotation axis of the photoconductive drum. It is preferable that, in the photoconductive drum set horizontally, a contact position where the tip surface of the brush 63 is in contact with the surface of the photoconductive drum is set below a horizontal surface passing the center axis of the photoconductive drum and the brush 63 is urged to the surface of the photoconductive drum from obliquely below the contact position.

The brush assembly can freely move in directions of the arrows Aa and Ab while being guided by the brush guide 61. Thus, even if the surface of the photoconductive drum 3a (3b, 3c, or 3d) is eccentric with respect to the rotation center axis, the tips of the brush fibers slide on the surface of the photoconductive drum in a state in which the tips of the brush fibers move in the directions of the arrows Aa and Ab while always following the surface of the photoconductive drum and are in contact with the surface of the photoconductive drum substantially perpendicularly (in a normal direction). In other words, the brush (the memory removing member) is provided retractably with respect to the surface of the photoconductive member (the image bearing member). In this case, it is preferable that the brush fibers have strength for preventing the brush fibers from easily bending (sturdy). It is preferable that attention is paid to prevent a large number of brush fibers from bending to rub the surface of the photoconductive drum with the sides of the brush fibers. It goes without saying that a small number of brush fibers may bend and the sides of the small number of brush fibers may come into contact with the photoconductive member.

In this example, a force acting in the arrow Aa direction is a vector component in the arrow Aa direction of an own weight of the brush assembly of the brush unit 60. Since the tips of the brush fibers are brought into contact with the outer surface of the photoconductive drum by the own weight of the brush assembly, a residual toner remaining on the surface of the photoconductive drum after transfer is efficiently perturbed (memory removal) and filming is less easily caused on the surface of the photoconductive drum. In the above explanation, the tips of the brush fibers form a plane. However, the same effect is obtained with a curved surface along the outer surface of the photoconductive drum.

In the case described above, the brush fibers are preferably brush fibers having a Young's modulus in a range of 1700 N/mm² to 3700 N/mm². As an example, when a brush made of acrylic fibers is used, there is an effect in prevention of filming. A conductive brush in which carbon was dispersed was adopted as the brush 63. A bias (±100 V to 500 V), which had a polarity opposite to that of charges of a toner and was equal to or lower than a discharge start voltage, was applied to the brush 63. Specifically, since the charges of the toner had a negative polarity, the bias applied to the brush was set to +300 V. Consequently, the toner could be attracted to the brush side to improve the effect of prevention of filming. The bias applied the brush is not always limited as in this example. For example, it is also effective to apply a bias of a polarity same as that of the toner to charge the toner with a minus polarity to cause the toner pass or apply a pulse bias with repetition of ON and OFF to the brush to perturb the toner. It is possible to collect the toner adhering to the brush 63 by providing a not-shown toner receiver below the brush 63. It is possible to efficiently collect the toner in the developing device by perturbing the toner.

### Second Embodiment

A second embodiment of the image forming apparatus of the invention will be explained. FIG. 4 is a diagram for explaining a brush unit of a memory removing device used in the second embodiment of the image forming apparatus of the invention. A brush unit 70 in FIG. 4 includes an arm attaching shaft 71 attached to an image forming apparatus body, a brush arm 72 attached at one end by the arm attaching shaft 71 to freely rotate in directions of arrows Ba and Bb, and a brush 73 planted at the other end of the brush arm 72. This brush 73 also extends at a fixed width (shown in a sectional view in FIG. 4) in an axial direction of a photoconductive drum in the same degree as the rotor drum. This brush unit 70 is actually constituted by attaching a brush 73, which is manufactured by bonding a conductive cloth interwoven with acrylic fibers having thickness of 6 deniers (a diameter of about φ25 μm) at a density of 100 kF (the number of filaments per a unit area) on a metal plate having a thickness of 1.5 mm and cutting the cloth to have a fiber length of 5 mm, to the brush arm 72.

In this brush unit 70, a structural relation between the brush 73 and the photoconductive drum 3a (3b, 3c, or 3d) is the same as that in the brush unit 60. The brush unit 70 is preferably assembled such that, when the brush 73 and the photoconductive drum come into contact with each other, concerning the tip plane formed by the tips of the brush fibers, a center line of the tip plane extending along the length direction of the photoconductive drum is parallel to a rotation axis of the photoconductive drum and the rotation axis of the photoconductive drum is placed on an imaginary plane that passes the center line of the tip plane and is perpendicular to the tip plane. In other words, it is preferable that, in the brush unit 70, when the tip plane formed by the tips of the brush fibers comes into contact with the surface of the photoconductive drum, the tip plane is opposed to the rotation axis of the photoconductive drum.

This is because, since the tips of the brush fibers are opposed to the rotation axis of the photoconductive drum, even if eccentricity, rotation vibration, or the like of the drum occurs, the tips of the brush fibers always follow the eccentricity, the rotation vibration, or the like of the drum and easily cope with the eccentricity, the rotation vibration, or the like freely to substantially perpendicularly come into contact with the surface of the photoconductive drum.

Preferable characteristics of the brush fibers used in the brush 73 of the brush unit 70 will be explained. As the brush fibers used in the brush 73, a brush fibers having a Young's modulus of 1700 N/mm² to 3700 N/mm² is preferable. When a brush made of acrylic fibers was used as a type of the brush 73, as shown in Table 1, an effect of measures against filming was observed. When a nylon brush having a Young's modulus of 1000 to 1700 was used, the effect of measures against filming was insufficient. The effect was also observed in a polyester brush having a Young's modulus of 3100 to 3700 N/mm².

On the other hand, when vinylon having a Young's modulus of 7500 N/mm² was used, a large number of scratches were caused on the surface of the photoconductive member and a defect of a white streak occurred in an image. Therefore, it has been found that a Young's modulus of the brush fibers is preferably in a range of 1700 N/mm² to 3700 N/mm².

TABLE 1

| | Young's | Fineness | | |
|---|---|---|---|---|
| Brush | modulus | (thickness) | | Life test result |
| material | (N/mm₂) | (Denier) | Density | (filming evaluation) |
| Nylon | 1000 to 1700 | 6 | 100 kF | Bad |
| Acrylic | 1500 to 3350 | 6 | 100 kF | Good |
| Polyester | 3100 to 3700 | 6 | 100 kF | Good |
| Vinylon | 7500 | 6 | 100 kF | White streak |
| | | | | occurred |

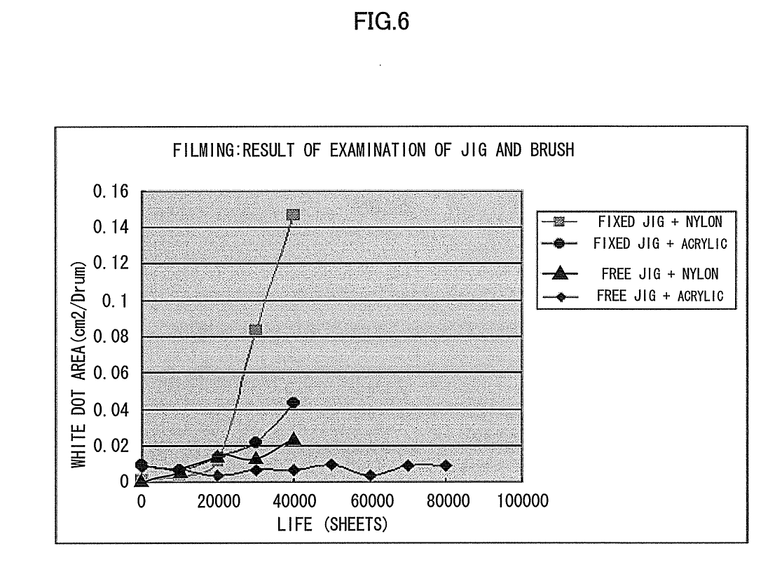

FIG. 6 is a graph showing a result of performing a filming test for a nylon brush and an acrylic brush using a conventional fixed jig and a jig by a Free mechanism (e.g., FIG. 3) according to this embodiment. In both the jigs, as brushes, the nylon brush and the acrylic brush described in Table 1 were used. In the conventional method in which movement of a brush was fixed, filming occurred when a life test for image formation on about 40000 sheets was performed using whichever of the brushes. When the Free mechanism was used, concerning the nylon brush, filming slightly occurred at a point of image formation on 40000 sheets. Since the brush fibers easily bent (a Young's modulus thereof was small), the effect of prevention of filming was insufficient. On the other hand, when movement of the brush was free and the acrylic brush was used, filming did not occur even if the life test for image formation on 80000 or more sheets was performed.

### Third Embodiment

A third embodiment of the image forming apparatus of the invention will be explained. FIG. 5 is a diagram for explaining a brush unit of a memory removing device used in the third embodiment of the image forming apparatus of the invention. A brush unit 80 in FIG. 5 includes a brush frame 82 guided in linear directions indicated by arrows Ca and Cb by a not-shown brush guide, a brush 83 attached to the brush frame 82, and a spring (an elastic body) 84 that sets the brush 83 in contact with a photoconductive drum. The spring 84 sets a brush assembly including the brush frame 82 and the brush 83 retractably in contact with the photoconductive drum. The brush unit 80 extends in an axial direction of the photoconductive drum in the same degree as the rotor drum. The brush 83 also extends at a substantially fixed width in the axial direction of the photoconductive drum in the same degree as the photoconductive drum. The brush 83 is made slidable in the axial direction of the photoconductive drum. In this regards, the brush unit 80 is similar to the brush unit 60 in FIG. 3. However, the brush unit 80 is different from the brush unit 60 in that, since an own weight of the brush 83 does not act as a contact force on the photoconductive drum, the spring 84 is used. A spring pressure in this example is set to a degree slightly larger than a sum of a moving direction component of a weight of the brush assembly and a frictional force applied to the brush assembly by the brush guide. The brush guide only has to appropriately support the brush frame 82 from the outer side.

Other embodiments to which the memory removing device that uses the brush unit is applied and confirmation of effects will be hereinafter explained.

(Application 1)

A conductive brush in which carbon is dispersed may be adopted as the brush member that is brought into contact with the surface of the photoconductive member. A bias (100 V to 500 V) that has a polarity opposite to that of charges of a toner and is equal to or lower than a discharge start voltage may be applied to the brush. Since charges of the toner used in this embodiment have a negative polarity, a bias applied to the brush is set to +300 V. Consequently, it is possible to attract the toner to the brush side to improve the effect of prevention of filming. Moreover, an electrostatic force is added to a contact force of the brush to the photoconductive member, and a stronger perturbation effect is realized. Moreover, since the brush assembly is held by the Free mechanism as in this embodiment, it is possible to realize scraping of the toner by the tips of the brush fibers rather than the sides of the brush fibers.

(Application 2)

A bias applied to the brush is not always limited as in the application 1. For example, it is also effective to recharge the toner by applying a bias of a polarity same as the polarity of the charges of the toner, set the charges of the toner uniform to cause the toner to pass, or perturb the toner by applying a pulse bias with repetition of ON and OFF.

(Confirmation of Effects)

As the Free mechanism in which the brush jig is movable perpendicularly to a tangential line of the surface of the photoconductive member, a mechanism in which a brush formed on a sheet metal is placed in a holder and made movable in the vertical direction with respect to the surface of the photoconductive member (FIG. 3 described above) and a structure supported by a pressure spring (FIG. 5) are also effective. When the brush is pressed by the spring, as described above, it is necessary to set a pressure force to a degree slightly larger than a sum of a moving direction component of a weight of the brush and a frictional force between the brush and the holder and adjust the pressure force such that the tip of the brush comes into contact with the surface of the photoconductive member.

Embodiments of the driving unit of the filming preventing device described above will be explained. In a cleanerless process in which a two component developer is used, other than the problem of filming, there is a problem in that, since a cleaning blade for a photoconductive member is not provided, a carrier adhering to the photoconductive member adheres to a brush and scrapes the surface of the photoconductive member in a streak shape to cause a defect of the streak shape on a halftone image. In order to solve this problem, there is proposed an image forming apparatus of a cleanerless system in which filming is eliminated and an image defect due to streak-like scratches on a photoconductive member is eliminated by setting a brush movable in the vertical direction with respect to a tangential line of the photoconductive member and causing the brush to reciprocatingly move in a longitudinal direction of the photoconductive member (a direction along a rotation axis of the photoconductive drum). An effect of causing a carrier adhering to the brush to pass by causing the brush to reciprocatingly move in the lateral direction (the longitudinal direction of the photoconductive member) is given to the image forming apparatus.

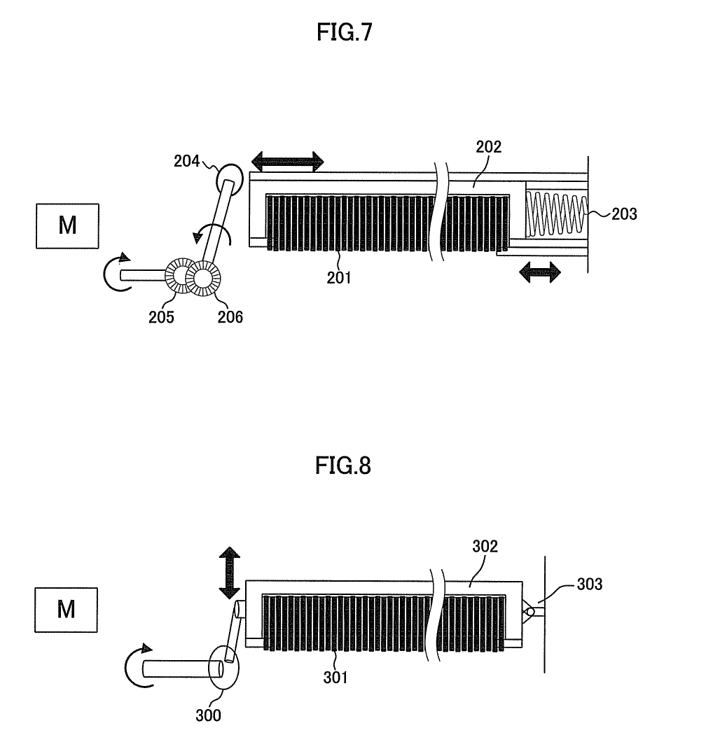

For example, as in an embodiment shown in FIG. 7, there is a mechanism in which a brush 201 is placed in a holder (a guide, guiding means) 202, a spring 203 is arranged in one side in a longitudinal direction of a photoconductive member, and the holder 202 is pushed in the opposite direction from the opposite side using a cam 204. It is possible to adjust an impact of vibration according to a shape of the cam. Gears 205 and 206 of a trapezoidal shape are arranged to mesh with each other in a direction of 90 degrees and a driving force generated by a motor (a driving unit or driving means) M from an apparatus body side is transmitted to the cam 204 by the gears 205 and 206 to push the holder 202 according to rotation of the cam 204. On the other hand, the holder 202 is pushed to the opposite side of the holder 202 by an urging force generated by the spring 203. The brush holder reciprocatingly moves according to pressures from both the sides.

Alternatively, as in an embodiment shown in FIG. 8, a motor driving force from the apparatus body side is transmitted to a holder 302, to which a brush 301 is attached, using a crank 300 to cause the holder 302 to move up and down. In this example, the opposite side is held by a rotatable bearing 303. Consequently, the holder 302 reciprocatingly moves in a rotation direction with the bearing as the center. In this way, the brush is caused to reciprocatingly move along an axial direction of the photoconductive drum in FIG. 7 or a moving direction of the surface of the photoconductive drum in FIG. 8 as the direction along the surface of the photoconductive member.

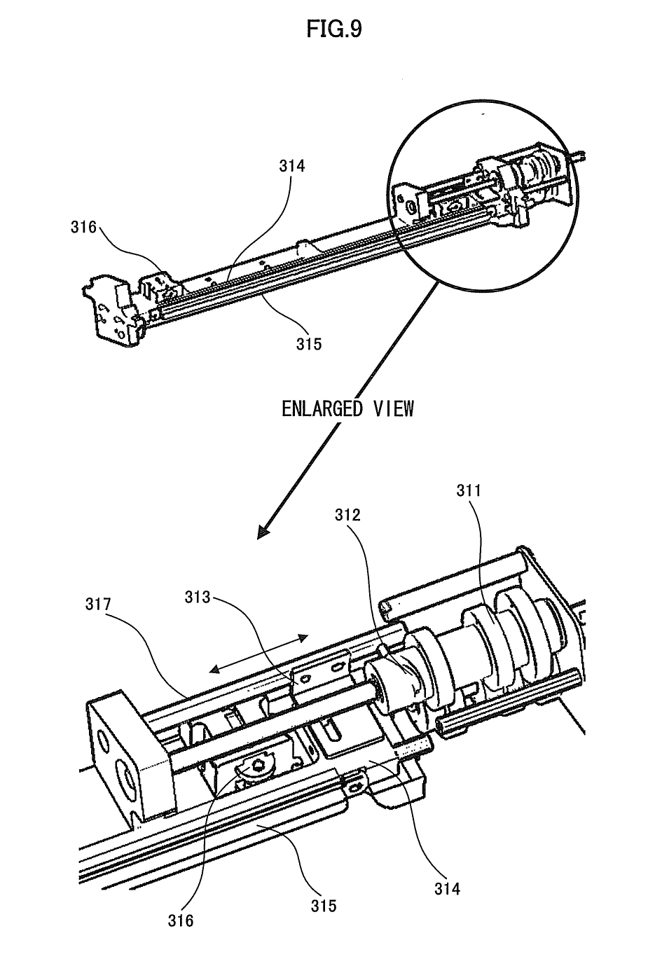

A result due to a difference in an urging force at the time when the brush comes into contact with the outer surface of the photoconductive drum (a brush load and a filming evaluation result) will be explained with reference to FIG. 9. In a lateral direction (the longitudinal direction of the photoconductive member) sliding mechanism (a driving unit) in FIG. 9, a rotation driving gear 311 rotates, whereby a rotation-lateral driving converting spiral groove 312 rotates. According to this rotation, a transmission bar 317 connected to a lateral-slide driving transmission plate 313 is driven to reciprocatingly move in a direction of a straight line arrow. Therefore, the lateral-slide driving transmission plate 313 drives a brush holder 314 and a brush 315 to reciprocatingly move along the direction of the straight line arrow. In this case, mechanisms that can adjust a contact force (a spring load 316) of the brush 315 are arranged at both the ends of the brush holder 314. The transmission bar 317, the lateral-slide driving transmission plate 313, and the brush holder 314 constitute the guide or the guide means according to this embodiment. The rotation driving gear 311 constitutes the not-shown driving unit or driving means according to this embodiment.

In the lateral direction sliding mechanism in FIG. 9, a filming test was performed by setting springs having an urging force of 70 gft at both the ends of the brush holder to urge the brush holder with a total load of 140 g. As a result, filming slightly occurred and could not be completely prevented. Further, spring tests were performed by setting springs having an urging force of 100 gft urge the brush holder with a load of 200 g, setting springs having an urging force of 150 gft urge the brush holder with a total load of 300 g, and setting springs having an urging force of 250 gft urge the brush holder with a total load of 500 g. As a result, in a life test equivalent to printing on 60000 sheets, a satisfactory result without occurrence of filming was obtained. Moreover, a filming test was performed by setting springs having an urging force of 300 gft urge the brush holder with a total load of 600 g. As a result, the surface of the photoconductive drum was roughened severely and a fall in an image density was observed. These results are summarized in Table 2 below.

TABLE 2

| Brush load (g) | Filming evaluation result |
|---|---|
| 140 | Fair |
| 200 | Good |
| 300 | Good |
| 500 | Good |
| 600 | (Roughening of photoconductive |
| | member is conspicuous) |

From these results, it can be said that it is effective to give a spring load in a range of 200 g to 500 g.

A filming test was performed by changing a period of brush lateral slide. A brush lateral slide period and a film evaluation result are as shown in Table 3 below.

TABLE 3

| Brush lateral slide period | |
|---|---|
| (per one rotation of the | |
| photoconductive member) | Filming evaluation result |
| 0.25 | Fair |
| 0.5 | Good |
| 2 | Good |
| 3 | Good |
| 4 | Roughening occurred |

From these results, it can be said that the effect of prevention of filming is small when the brush lateral slide period per one rotation of the photoconductive member is equal to or smaller than 0.25 (the brush reciprocatingly moves once while the photoconductive member rotates four times) and roughening of the photoconductive member is severe when the brush lateral slide period per one rotation of the photoconductive member is equal to or larger than 4 (the brush reciprocatingly moves four times while the photoconductive member rotates once). Therefore, it can be said that, the brush lateral slide period per one rotation of the photoconductive member of 0.5 to 3 is effective.

When a peripheral length of the photoconductive drum is L, an integer is n, and the lateral slide period of the brush is I, it is preferable to drive the brush such that nL≠I holds concerning lateral slide of the brush. This is because, if nL=I holds, the brush always performs brushing on the same locus and the effect of prevention of filming is deteriorated.

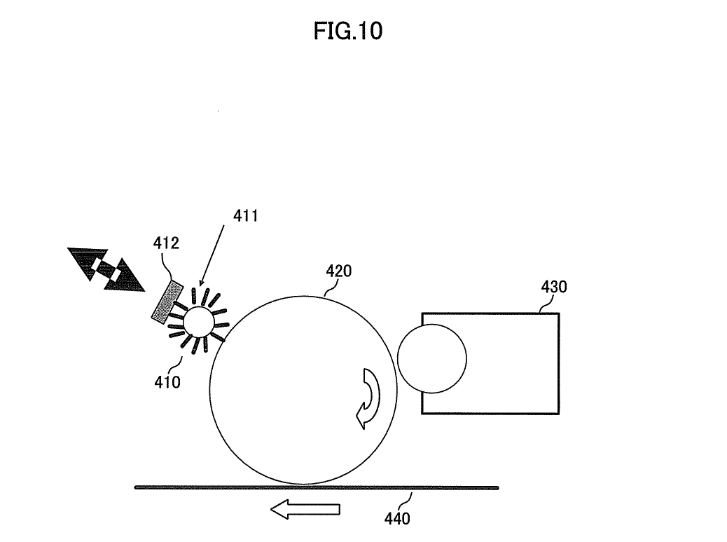

Moreover, concerning the image forming apparatus of the two component development system, as shown in FIG. 10, a rotary brush 410 is arranged and driven by a sliding mechanism 411 and a magnet 412 is arranged in contact with the rotary brush 410. Consequently, it is possible to remove a carrier component adhering onto the photoconductive member 420 with the rotary brush 410 and further remove the carrier from the rotary brush 410 with the magnet 412. It is possible to prevent the photoconductive member 420 from being scratched. The rotary brush 410 may rotate following the photoconductive member 420 or may be controlled by gear driving to rotate at a certain period in association with the rotation of the photoconductive member 420. In FIG. 10, reference numeral 430 denotes a developing device and 440 denotes a transfer belt. As a memory removing member other than the brush, a foamed elastic body like a sponge, an elastic body of a thin plate shape like a resin film, or the like may be disposed in the axial direction of the photoconductive member.

What is claimed is:

1. An image forming apparatus of a cleanerless process system comprising:
an image bearing member on which a latent image is visualized by a toner and transferred; and
a memory removing member that is set retractably in contact with a surface of the image bearing member and provided to be slidable along the surface of the image bearing member.

2. An image forming apparatus according to claim 1, wherein the memory removing member is slidable in, as a direction of the surface of the image bearing member, a direction orthogonal to a moving direction of the surface of the image bearing member.

3. An image forming apparatus according to claim 1, wherein
the image bearing member is a photoconductive drum set horizontally,
a contact position where the memory removing member is in contact with the surface of the photoconductive drum is set below a horizontal surface that passes a center axis of the photoconductive drum, and
the memory removing member is urged to the surface of the drum from obliquely below the contact position.

4. An image forming apparatus according to claim 1, wherein, when a peripheral length of the image bearing member is L, an integer is n, and a rotation period of the image bearing member is I, the memory removing member is driven to reciprocatingly move on the surface of the image bearing member such that nL≠I holds and slides on the surface of the image bearing member.

5. An image forming apparatus according to claim 4, wherein a period of the reciprocating movement of the memory removing member is from one reciprocating movement per two rotational actions of the image bearing member to three reciprocating movements per one rotational action of the image bearing member.

6. An image forming apparatus according to claim 1, wherein a pressing force of the memory removing member against the surface of the image bearing member is 200 g-wt to 500 g-wt.

7. An image forming apparatus according to claim 1, wherein the memory removing member is arranged between a downstream side of a transferring unit and an upstream side of a charging unit with respect to a moving direction of the image bearing member.

8. An image forming apparatus according to claim 1, wherein the image bearing member is a photoconductive drum and includes:
a guide configured to guide the memory removing member in a sliding direction; and
a driving unit configured to guide the memory removing member in accordance with the guide.

9. An image forming apparatus according to claim 1, wherein
the image bearing member is a photoconductive drum,
the memory removing member has an arm provided with the arm removing member provided at one end, the other end of the arm is attached by an arm attaching shaft to freely rotate around the arm attaching shaft and the arm is made slidable in a direction of the arm attaching shaft, a contact position where a tip of the memory removing member is in contact with a surface of the photoconductive drum is set above a horizontal surface that passes a center axis of the photoconductive drum set horizontally, the arm attaching shaft is set above the contact position, the tip of the memory removing member is in contact with the surface of the photoconductive drum according to rotation by an own weight of the memory removing member including a structure around the arm attaching shaft.

10. An image forming apparatus according to claim 3, further comprising:
a memory removing member guide that guides the memory removing member with respect to the surface of the photoconductive drum; and
an elastic body that urges the memory removing member in a direction of guide by the memory removing member guide.

11. An image forming apparatus according to claim 1, wherein the image bearing member and the memory removing member are integrally supported as one cartridge and detachably attachable to a body of the image forming apparatus.

12. An image forming apparatus of a cleanerless process system comprising:
image bearing means on which a latent image is visualized by a toner and transferred; and
memory removing means that is set retractably in contact with a surface of the image bearing means and provided to be slidable with respect to a direction of the surface of the image bearing means.

13. An image forming apparatus according to claim 12, wherein the memory removing means is slidable in, as a direction of the surface of the image bearing means, a direction orthogonal to a moving direction of the surface of the image bearing means.

14. An image forming apparatus according to claim 12, wherein, when a peripheral length of the image bearing means is L, an integer is n, and a rotation period of the image bearing means is I, the memory removing means is driven to reciprocatingly move on the surface of the image bearing means such that nL≠I holds and slides on the surface of the image bearing means.

15. An image forming apparatus according to claim 12, wherein a period of the reciprocating movement of the memory removing means is from one reciprocating movement per two rotational actions of the image bearing means to three reciprocating movements per one rotational action of the image bearing means.

16. An image forming apparatus according to claim 12, wherein a pressing force of the memory removing means against the surface of the image bearing means is 200 g-wt to 500 g-wt.

17. An image forming apparatus according to claim 12, wherein the memory removing means is arranged between a downstream side of transferring means and an upstream side of charging means with respect to a moving direction of the image bearing means.

18. An image forming apparatus according to claim 12, wherein the image bearing means is a photoconductive drum and includes:
guide means for guiding the memory removing means in a sliding direction; and
driving means for driving the memory removing means in accordance with the guide means.

19. An image forming method of a cleanerless process system comprising:
setting a memory removing member retractably in contact with a surface of an image bearing member; and
sliding the memory removing member in a direction along the surface of the image bearing member.

20. An image forming method according to claim 19, wherein the memory removing member is slid in, as a direction along the surface of the image bearing member, a direction orthogonal to a moving direction of the surface of the image bearing member.
